(19) United States
(12) Patent Application Publication
(10) Pub. No.: US 2009/0133240 A1
(43) Pub. Date: May 28, 2009

(54) CONVEYING AND ASSEMBLING SYSTEM

(76) Inventors: Takao Shibayama, Saitama (JP); Masaru Maruo, Saitama (JP); Yoshito Ohtake, Saitama (JP); Tetsuya Ozawa, Saitama (JP)

Correspondence Address: ARENT FOX LLP, 1050 CONNECTICUT AVENUE, N.W., SUITE 400, WASHINGTON, DC, 20036, US

(21) Appl. No.: 12/065,806

(22) PCT Filed: Sep. 5, 2005
(86) PCT No.: PCT/JP2005/016274

§ 371 Date: Mar. 5, 2008

(51) Int. Cl. B25B 27/14

(52) U.S. Cl. 29/281.5

(57) ABSTRACT

To provide a conveying and assembling system in which an operation area where a person coexisting type assembling device and an operator coexist is efficiency distributed, The operation area includes an area A1 where a person coexisting type assembling device R and an operator SS cooperate, an area A2 where the person coexisting type assembling device independently moves, and areas A3 and A4 where the operator independently operates while the person coexisting type assembling device R independently moves. In the operation area, a main line ML along which a vehicle body W moves in the arrow direction (leftward) in a suspended manner, a sub line SL along which the person coexisting type assembling device R travels, a tank mounting base TB, a tank housing shelf TT, and a component mounting base BB are provided. The main line ML partly overlaps the area A1, the sub line SL intersects the main line ML and is partly arranged in parallel with the main line ML, and overlaps the area A2 where the person coexisting type assembling device independently moves.

### TECHNICAL FIELD

The present invention relates to a conveying and assembling system in which an operator and a person coexisting type assembling device coexist.

### BACKGROUND ART

A known conveying and assembling system in which an operator and a robot coexist is a movable robot system disclosed in Patent Document 1. Patent Document 1 discloses a system in which a robot is movably placed between a facility 1 for receiving a workpiece, a facility 2 for machining the workpiece, and a facility 3 constituted by a conveyor, the workpiece received by the facility 1 is machined by the facility 2, and the machined workpiece is transferred to the facility 3 by the robot. Particularly, the facilities 1 and 3 are areas where an operator and the robot coexist. In these areas, a torque limiter is provided in a motor drive circuit of the robot and an output of a motor for driving an arm of the robot is limited to 80 W or lower for safety of the operator.

Patent Document 2 discloses a technique using an auxiliary device in which when various components are mounted to a vehicle body under conveyance in a vehicle assembly line, a heavy component is supported by a manipulator, an operator's force indirectly applied to the heavy component is detected by a force sensor, and based on information on the force, the manipulator is controlled to reduce a burden on a person.

### Patent Document 1: Japanese Patent Application Publication No. 2001-341086

### Patent Document 2: Japanese Patent Application Publication No. 2000-84881

### DISCLOSURE OF THE INVENTION

The robot disclosed in Patent Document 1 does not cooperate with the operator to perform one operation, but performs a completely different operation from that performed by the operator. Specifically, the operator and the robot do not efficiently perform a series of operations while covering mutual weaknesses (a robot has a difficulty in precise positioning and discrimination of components, while a person has a difficulty in lifting heavy objects). Thus, Patent Document 1 does not disclose or suggest an efficient way of distribution of one operation area.

The robot disclosed in Patent Document 2 is always manually operated. If a person takes his/her hand off, the operation is stopped, and the robot does not independently operate. Thus, there is no idea of distributing an area between the robot and the operator for efficient operations.

An object of the present invention is that a person coexisting type assembling device, that is, a robot, which cooperates with an operator to perform some operations and automatically performs the other operations, and the operator efficiently operate in a shared operation area.

To achieve this object, in a conveying and assembling system according to the present invention, one operation area is classified into an area where a person coexisting type assembling device and an operator cooperate, an area where the person coexisting type assembling device independently moves, and an area where the operator independently operates while the person coexisting type assembling device independently moves.

As an example, the area where the person coexisting type assembling device and the operator cooperate is an area where a component is assembled to a vehicle body, the area where the person coexisting type assembling device independently moves is an area extending from a component supply portion to the area where the component is assembled to the vehicle body, and the area where the operator independently operates is an area that is not associated with the above described two areas.

According to the present invention, the robot and the operator cooperate to perform one operation in one operation area only when required, and independently operate in other times, thereby significantly increasing operation efficiency. The areas for the independent operations are separated, thereby preventing interference between the robot and the operator and ensuring security.

### BRIEF DESCRIPTION OF THE DRAWINGS

FIG. 1 is a plan view of an operation area to which a conveying and assembling system according to the present invention is applied;

FIG. 2 is a side view of an area where a person coexisting type assembling device and an operator cooperate; and

FIG. 3 is a side view of another embodiment of a person coexisting type assembling device.

### BEST MODE FOR CARRYING OUT THE INVENTION

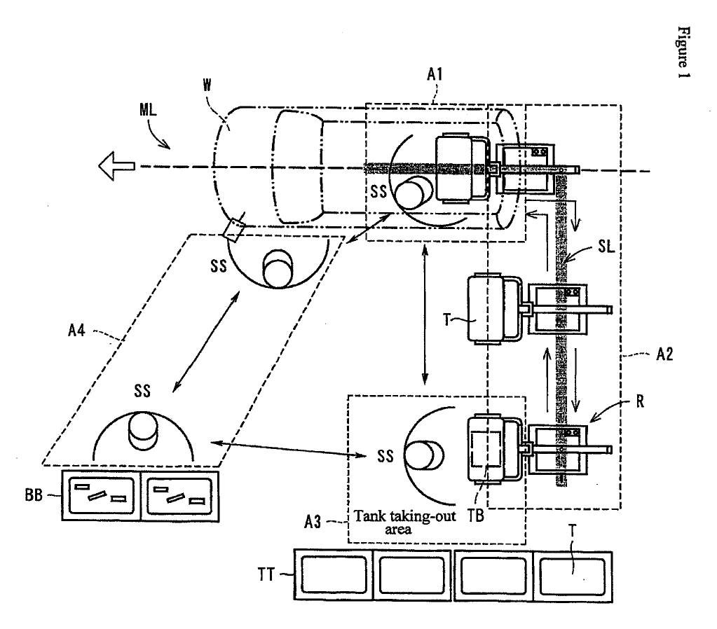

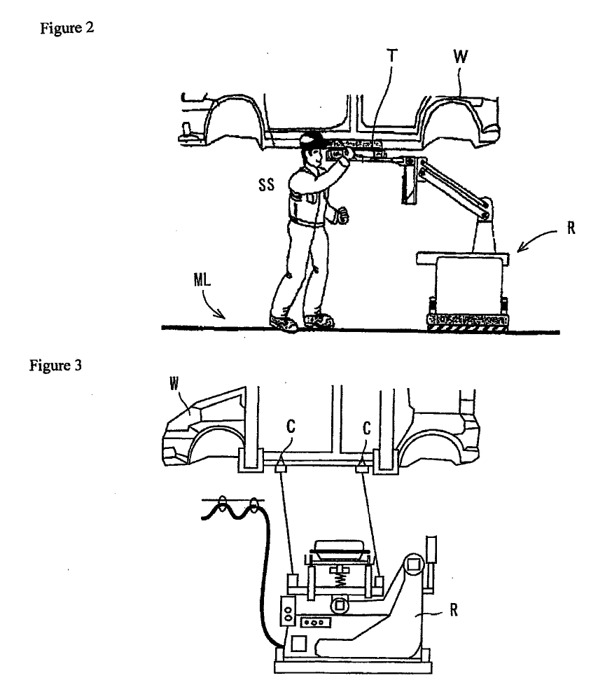

Now, embodiments of the present invention will be described with reference to the accompanying drawings. FIG. 1 is a plan view of an operation area to which a conveying and assembling system according to the present invention is applied, and FIG. 2 is a side view of an area where a person coexisting type assembling device and an operator cooperate.

As shown in FIG. 1, an operation area includes an area A1 where a person coexisting type assembling device R (self-running power assist device) and an operator SS cooperate, an area A2 where the person coexisting type assembling device independently moves, and areas A3 and A4 where the operator independently operates while the person coexisting type assembling device R independently moves.

In the operation area, a main line ML along which a vehicle body W moves in the arrow direction (leftward) in a suspended manner, a sub line SL along which the person coexisting type assembling device R travels, a tank mounting base TB, a tank housing shelf TT, and a component mounting base BB are provided. The main line ML partly overlaps the area A1, the sub line SL intersects the main line ML and is partly arranged in parallel with the main line ML, and overlaps the area A2 where the person coexisting type assembling device R independently moves.

In the area A3, the operator SS transfers a tank T from the tank housing shelf TT to the tank mounting base TB while the person coexisting type assembling device R independently moves. In the area A4, the same operator SS takes out a component and mounts the component to the vehicle body W after the operator transfers the tank T from the tank housing shelf TT to the tank mounting base TB and while the person coexisting type assembling device R independently moves.

The person coexisting type assembling device R having held the tank T from the tank mounting base TB travels along the sub line SL. When the person coexisting type assembling device R reaches below the vehicle body W, that is, the area A1 where the person coexisting type assembling device R and the operator SS cooperate as shown in FIG. 2, the operator SS stops other operations and cooperates with the person coexisting type assembling device R to mount the tank T to the vehicle body W in the area A1.

Specifically, since an arm of the person coexisting type assembling device R can be moved by the operator by a small force, the operator SS moves the arm holding the tank T to a mounting position on the vehicle body W, and then the person coexisting type assembling device R automatically mounts the tank T to the vehicle body W. In this embodiment, the person and the robot cooperate to mount the tank T, the operator transfers the tank T from the tank housing shelf TT to the tank mounting base TB, and the robot transfers the tank T to below the vehicle body. The tank T may be manually mounted to the vehicle body W.

After the cooperation (positioning of the arm) with the person coexisting type assembling device R, the operator returns to the area A3, transfers a new tank T to the tank mounting base TB while the person coexisting type assembling device R travels back through the area A2, and as described above, moves to the area A4 and takes out a component, and mounts the component to a vehicle body. After the operation, in the area A1, the operator again cooperates with the person coexisting type assembling device R to mount the tank T to the vehicle body W.

In the embodiment, the example of one operator has been described. However, when an operation time and a traveling time of the person coexisting type assembling device R are short, two operators may separately take out a tank T and mount a component.

FIG. 3 is a side view of another embodiment of a person coexisting type assembling device. In this embodiment, a person coexisting type assembling device R has a clip C, an operator connects the clip C to part of a vehicle body W, the person coexisting type assembling device R is moved in synchronization with traveling of the vehicle body W, and during this movement, the operator moves an arm of the person coexisting type assembling device R to a tank mounting position. This allows mounting while moving the vehicle body W, thereby reducing total operation time.

1. A conveying and assembling system characterized in that an operation area is classified into an area where a person coexisting type assembling device and an operator cooperate, an area where the person coexisting type assembling device independently moves, and an area where the operator independently operates while the person coexisting type assembling device independently moves.

2. The conveying and assembling system according to claim 1, characterized in that said area where the person coexisting type assembling device and the operator cooperate is an area where a component is assembled to a vehicle body, said area where the person coexisting type assembling device independently moves is an area extending from a component supply portion to the area where the component is assembled to the vehicle body, and said area where the operator independently operates is an area that is not associated with said two areas.
